(19) United States
(12) Patent Application Publication
(10) Pub. No.: US 2023/0377215 A1
(43) Pub. Date: Nov. 23, 2023

(54) ADAPTIVE COLOR MAPPING BASED ON BEHIND-DISPLAY CONTENT MEASURED BY WORLD-VIEW CAMERA

(71) Applicant: Google LLC, Mountain View, CA (US)

(72) Inventors: Dongeek Shin, Santa Clara, CA (US); Aveek Purohit, Palo Alto, CA (US)

(21) Appl. No.: 17/663,972

(22) Filed: May 18, 2022

(51) Int. Cl. G06T 11/00; G06V 10/25; G06T 11/60; G06V 10/56; G06V 10/70; G06T 7/90

(52) U.S. Cl. CPC G06T 11/001; G06V 10/25; G06T 11/60; G06V 10/56; G06V 10/70; G06T 7/90; G06T 2207/10024; G06T 2207/20081

(57) ABSTRACT

A method can include selecting an image from a set of images captured by a camera of a wearable device, identifying a region of interest in the image based on a position of an overlay display of the wearable device, determining a characteristic of the region of interest, determining a characteristic of content to be rendered on the overlay display, modifying the content based on the characteristic of the region of interest and the characteristic of the content, and rendering the modified content on the overlay display.

### FIELD

Implementations relate to rendering content on a display of a wearable device.

### BACKGROUND

Virtual reality (VR)/augmented reality (AR) devices typically include sensors that can detect environmental conditions. The detected environmental conditions can be analyzed, and the results of the analysis can be used to adapt parameters of a display of the VR/AR device (e.g., brightness, color temperature, and/or the like).

### SUMMARY

In a general aspect, a device, a system, a non-transitory computer-readable medium (having stored thereon computer executable program code which can be executed on a computer system), and/or a method can perform a process with a method including selecting an image from a set of images captured by a camera of a wearable device, identifying a region of interest in the image based on a position of an overlay display of the wearable device, determining a characteristic of the region of interest, determining a characteristic of content to be rendered on the overlay display, modifying the content based on the characteristic of the region of interest and the characteristic of the content, and rendering the modified content on the overlay display.

Implementations can include one or more of the following features. For example, the region of interest can include an extended view zone. The determining of the characteristic of the region of interest can include inputting the image into a machine learned model and receiving the characteristic of the region of interest from the machine learned model. The characteristic of the region of interest can include a first text and the characteristic of the content includes a second text that overlays a portion of the first text if rendered on the overlay display and the modifying of the content can include repositioning the second text such that a portion of the second text does not overlay the first text when rendering the modified content on the overlay display. The characteristic of the region of interest can include a first color and the characteristic of the content includes a second color that overlays a portion of the first color if rendered on the overlay display and the modifying of the content can include changing the second color to contrast the first color when rendering the modified content on the overlay display.

The characteristic of the region of interest can include a content that is substantially the same as a portion of the content to be rendered and the modifying of the content can include removing the portion of the content to be rendered. The wearable device can include a sensor and the modifying of the content can be based on an output of the sensor. The wearable device can include a sensor and the rendering of the modified content on the overlay display can be delayed based on an output of the sensor. The method can further include triggering a situational display operation, delaying the rendering of the modified content on the overlay display, determining the characteristic of content to be rendered includes an overlay object, and in response to determining the characteristic of content to be rendered includes the overlay object, rendering the modified content on the overlay display. The delaying of the rendering of the modified content can include delaying the rendering of a portion of the modified content. The method can further include modifying a parameter of the overlay display based on the characteristic of the region of interest and the characteristic of the content. The wearable device can include a sensor, and the method can further include modifying a parameter of the overlay display based on an output of the sensor. The wearable device can be communicatively coupled to a companion computing device, and at least a portion of processing can be performed on the companion computing device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates use of an overlay display according to an example implementation.

FIG. 2 illustrates a flow diagram for displaying modified content on an overlay display according to an example implementation.

FIG. 3 illustrates a method for rendering modified content on an overlay display according to an example implementation.

FIG. 4 illustrates a block diagram of a system according to an example implementation.

FIG. 5 illustrates a wearable device according to an example implementation.

FIG. 6 illustrates a block diagram of the rendering of a modified content according to an example implementation.

FIG. 7 illustrates a diagram of a situational display of the rendering of a modified content according to an example implementation.

FIG. 8 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Some wearable devices (e.g., smart glasses) use an overlay display, sometimes called a heads-up display (HUD). For example, an overlay display can overlay a lens of the wearable device. An image that is rendered onto the overlay display can be projected onto the overlay display. Therefore, the lens or a portion of the lens can be the medium on which an image is projected. The lens or a portion of the lens on which an image is projected can be the overlay display. The lens and/or the overlay display can be semi-transparent. Therefore, the real-world can be viewed, by a user, through the lens and/or the overlay display.

When rendering content on the overlay display, a background is likely to be a real-world view as viewed through a lens of the wearable device. Accordingly, when rendered, the content typically will not have a constant or previously known (e.g., at the time of generating the content) background. Therefore, when rendered, the content can be difficult to distinguish against the real-world background, can interfere with the user's view of the real-world, can dangerously interrupt the user (e.g., while driving), can interrupt the user at an inconvenient or an undesirable time (e.g., while resting at home), and/or the like.

Typical display adaptations are based on the environment the user is operating the wearable device. For example, a brightness of a display can be adapted based on ambient light as detected by a sensor, a color temperature of a display can be adapted based on ambient light as detected by a sensor, and the like. Adapting the brightness or color temperature can be insufficient when rendering content on an overlay display with a real-world background. Therefore, example implementations can be configured to modify the content based on a real-world view (e.g., that becomes the background) and the content prior to rendering the content on an overlay display.

Modifying the content (instead of or in addition to adapting parameters of the display) can improve the user's ability to view the content when rendered on the overlay display. Modifying the content can improve the user's experience (e.g., improve safety, prevent interruptions, and the like) when rendering the content on the overlay display. Modifying the content can conserve processing resources (e.g., by delaying or preventing the rendering) when rendering the content on the overlay display.

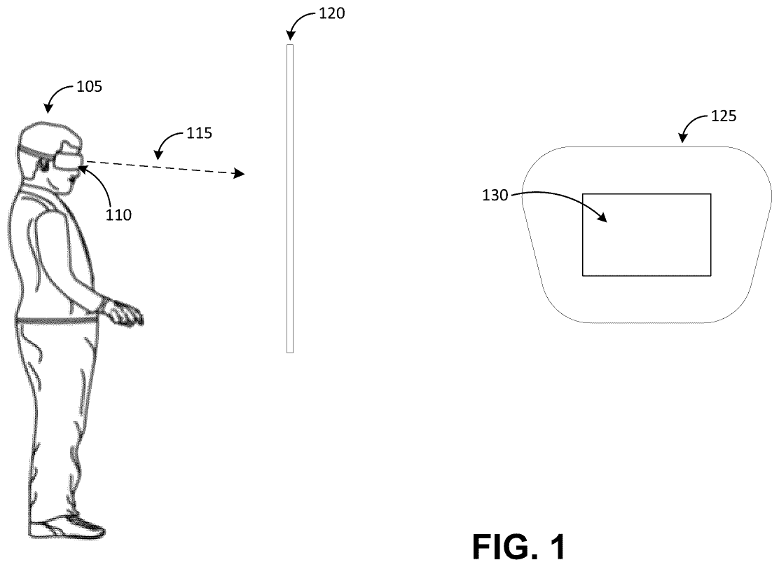

FIG. 1 illustrates use of an overlay display according to an example implementation. As shown in FIG. 1, a user 105 is wearing a wearable device 110. wearable device 110 can be, for example, a smart glasses, a head mounted display (HMD), an AR/VR device, a wearable computing device, and the like. The user is viewing a real-world view 120 in a direction indicated by line 115. The wearable device can include a lens 125. The lens 125 can include an overlay display 130 on which content can be rendered. For example, the overlay display 130 can overlay the lens 125 of the wearable device 110. An image that is rendered onto the overlay 130 display can be projected onto the overlay display 130. Therefore, the lens 125 or a portion of the lens 125 can be the medium on which an image is projected. The lens 125 or a portion of the lens 125 on which an image is projected can be the overlay display 130. The lens 125 and/or the overlay display 130 can be semi-transparent. Therefore, the real-world can be viewed (e.g., the real-world view 120), by the user 105, through the lens 125 and/or the overlay display 130.

The overlay display 130 can be positioned anywhere within the boundaries of the lens 125. In an example implementation, the overlay display 130 can be positioned such that a portion(s) of the lens 125 is not overlayed by the overlay display 130. For example, the overlay display 130 can be centered on the lens 125, can be to a left or right boundary of the lens 125, can be to a top or bottom boundary of the lens 125, and/or the like.

The user 105 can view the real-world view 120 through the lens 125. The overlay display 130 can be semi-transparent. Therefore, the real-world view 120 can be a background for any content that is rendered on the overlay display 130. Accordingly, as discussed above, the content can impact the user's view of the real-world and/or the real-world can impact the user's view of the content.

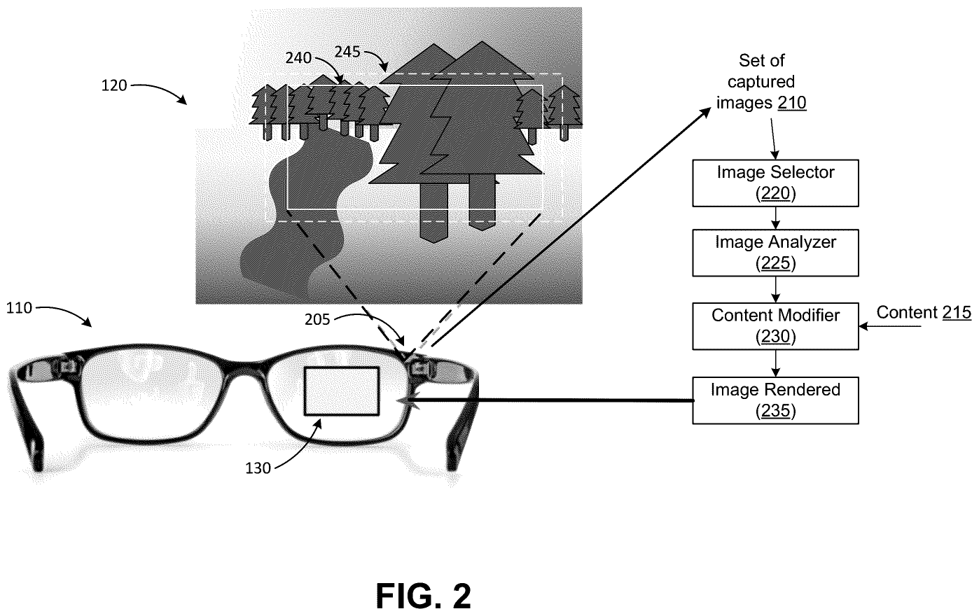

FIG. 2 illustrates a flow diagram for displaying modified content on an overlay display according to an example implementation. As shown in FIG. 2, the wearable device 110 can include a camera(s) 205 (e.g., a forward looking camera). The camera(s) 205 can be configured to capture a set of captured images 210. The set of captured images 210 can be captured sequentially in time. The set of captured images 210 can each be images of a real-world view (e.g., real-world view 120). The set of captured images 210 can be stored in a memory (not shown) of the wearable device 110 and/or a companion device associated with the wearable device 110.

An image selector 220 can be configured to select an image from the set of captured images 210. The image can be selected regularly (e.g., in predetermined time increments) and/or triggered based on a condition (e.g., a location, the conclusion of a time delay, and/or the like). An image analyzer 225 can be configured to identify a region of interest in the selected image based on a position of the overlay display 130 of the wearable device 110 and to determine a characteristic(s) of the region of interest.

The lenses (e.g., lens 125) and the overlay display 130 of the wearable device 110 can be semi-transparent. Therefore, the user 105 can view the real-world through the lenses and the overlay display 130. An image that is projected onto the overlay display 130 can have a portion of the real-world view (e.g., real-world view 120) as a background. An image (e.g., of the set of captured images 210) can represent the real-world view (e.g., real-world view 120). A portion of the image representing the real-world view may be relevant (e.g., for use by the image analyzer 225) with regard to the techniques described herein. For example, the portion of the image representing the real-world view that may be relevant can correspond to what can be viewed through the overlay display 130. In addition, the relevant portion of the image can be extended to improve the accuracy (e.g., reduce processing errors at a border) of any analysis of the relevant portion. The relevant portion of the image can be referred to as a region of interest. The extension can be referred to as an extended view zone.

The region of interest can correspond to a portion of the real-world view 120 as viewed through the overlay display 130. FIG. 2 illustrates the region of interest as an overlay portion 240 of the real-world view 120 corresponding to the portion of the real-world view 120 as viewed, by the user 105, through the overlay display 130. In addition, the region of interest can include an extended view zone 245 encompassing a boarder of the overlay portion 240. The extended view zone 245 can be used to increase the accuracy of the characteristic(s) of the region of interest as determined by the image analyzer 225 by extending the region of interest of the image used to determine the characteristic(s) of the region of interest.

The image analyzer 225 can be configured to use a deterministic function to determine the characteristic(s) of the region of interest. The image analyzer 225 can be configured to use a machine learned model to determine the characteristic(s) of the region of interest. The image analyzer 225 can be configured to use a deterministic function and a machine learned model to determine the characteristic(s) of the region of interest. For example, the image analyzer 225 can be configured to use a deterministic function to determine the characteristic(s) including a color, a brightness, a texture, text, text location, and/or the like. For example, the image analyzer 225 can be configured to use a machine learned model to determine the characteristic(s) including objects, object location, text, text associated with objects, situations (e.g., driving, walking, turning, and/or the like), and/or the like. For example, referring to FIG. 2, the image analyzer 225 may determine the region of interest, as the overlay portion 240 or the overlay portion 240 plus the extended view zone 245, includes a sky, a tree, a forest, and the location of each (e.g., using the machine learned model). The image analyzer 225 may also determine a color of the sky, a color of the tree, a color of the forest, and/or the like (e.g., using the deterministic function).

A content 215 can be an image configured to be rendered on the overlay display 130. A content modifier 230 can be configured to modify the content 215 based on the characteristic(s) of the region of interest and a characteristic(s) of the content 215. For example, the content modifier 230 can be configured to use a deterministic function to determine the characteristic(s) of the content 215. The content modifier 230 can be configured to use a machine learned model to determine the characteristic(s) of the content 215. The content modifier 230 can be configured to use a deterministic function and a machine learned model to determine the characteristic(s) of the content 215. For example, the content modifier 230 can be configured to use a deterministic function to determine the characteristic(s) including a color, a brightness, a texture, text, text location, and/or the like. For example, the content modifier 230 can be configured to use a machine learned model to determine the characteristic(s) including objects, object location, text, text associated with objects, situations (e.g., driving, walking, turning, and/or the like), and/or the like.

Modifying the content can include changing a color of an object, changing a color of text, changing a position of an object, changing a position of a text, removing an object, and/or the like. For example, if the characteristic(s) of the region of interest includes a content (e.g., an object) that is substantially the same as a portion of the content (e.g., an object) to be rendered, the modifying of the content can include removing the portion of the content to be rendered. Referring to FIG. 2, the characteristic(s) of the region of interest (e.g., overlay portion 240) includes trees. Therefore, if the portion of the content to be rendered includes trees, the modifying of the content can include removing the trees.

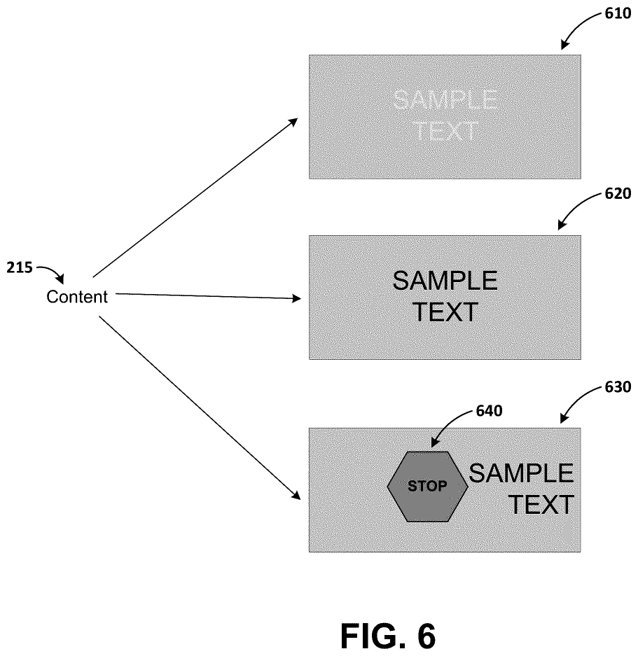

In an example implementation, referring to FIG. 6, the content 215 can include a text (e.g., shown as sample text). In block 610 (e.g., representing overlay display 130) the text (e.g., shown as sample text) may be rendered unmodified. In block 610 the text is substantially the same color as the background (e.g., representing a portion of real-world view 120). Therefore, the text can be somewhat indistinguishable (e.g., unreadable) against the background. In block 620 (e.g., representing overlay display 130) the text (e.g., shown as sample text) may be modified and then rendered. In block 620 a color of the text has been changed to be distinguishable against the color of the background (e.g., representing a portion of real-world view 120). Therefore, the text can be distinguishable (e.g., readable) against the background. In block 630 (e.g., representing overlay display 130) the text (e.g., shown as sample text) may be modified and then rendered. In block 620 a color of the text has been changed to be distinguishable against the color as the background (e.g., representing a portion of real-world view 120). In addition, the text has been repositioned (e.g., moved to the right) so as not to not overlay an object 640 (e.g., a stop sign) in the background that includes text. Therefore, the text can be distinguishable (e.g., readable) against the background.

An image renderer 235 can be configured to render the modified content 215 (e.g., as an image) on the overlay display 130. Rendering the modified content 215 can include displaying each pixel of the modified content 215 on the overlay display 130. Rendering the modified image can include projecting the modified content onto the overlay display 130. Rendering the modified content 215 can include pixel-by-pixel rasterization, primitive-by-primitive rasterization, ray casting, ray tracing, and/or the like. Rendering the modified content 215 can include converting the modified content 215 to a geometric representation and rasterizing the geometric representation.

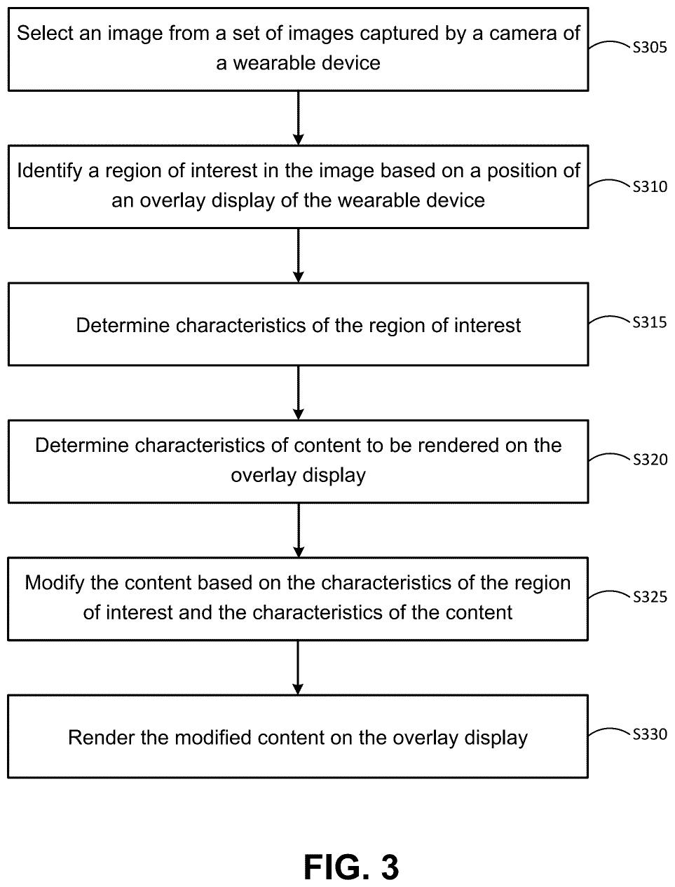

FIG. 3 illustrates a method for rendering modified content on an overlay display according to an example implementation. As shown in FIG. 3, in step S305 an image is selected from a set of images captured by a camera of a wearable device. For example, a set of captured images can be stored in a memory of a wearable device (e.g., wearable device 110) and/or associated with the wearable device. An image can be selected from the set of captured images. The image can be selected regularly (e.g., in predetermined time increments) and/or triggered based on a condition (e.g., a location, the conclusion of a time delay, and/or the like).

In step S310 a region of interest in the image is identified based on a position of an overlay display of the wearable device. For example, the region of interest can correspond to a portion of a real-world view as viewed through the overlay display. For example, FIG. 2 illustrates the overlay portion 240 of the real-world view 120 corresponding to the portion of the real-world view 120 as viewed through the overlay display 130. In addition, the region of interest can include an extended view zone 245 encompassing a boarder of the overlay portion 240. The extended view zone 245 can be used to increase the accuracy of the characteristic(s) of the region of interest as determined by the image analyzer 225.

In step S315 characteristic(s) of the region of interest are determined. For example, a deterministic function can be used to determine the characteristic(s) of the region of interest. For example, a machine learned model can be used to determine the characteristic(s) of the region of interest. For example, a deterministic function and a machine learned model can be used to determine the characteristic(s) of the region of interest. For example, a deterministic function can be used to determine the characteristic(s) including a color, a brightness, a texture, text, text location, and/or the like. For example, a machine learned model can be used to determine the characteristic(s) including objects, object location, text, text associated with objects, situations (e.g., driving, walking, turning, and/or the like), and/or the like. For example, referring to FIG. 2, the region of interest can be identified as the overlay portion 240 or the overlay portion 240 plus the extended view zone 245 which includes a sky, a tree, a forest, and the location of each can be determined using, for example, the machine learned model. A color of the sky, a color of the tree, a color of the forest, and/or the like can be determined using, for example, the deterministic function.

In step S320 characteristic(s) of content to be rendered on the overlay display is determined. For example, a deterministic function can be used to determine the characteristic(s) of the content (e.g., content 215). For example, a machine learned model can be used to determine the characteristic(s) of the content. For example, a deterministic function and a machine learned model can be used to determine the characteristic(s) of the content. For example, the deterministic function can be used to determine the characteristic(s) including a color, a brightness, a texture, text, text location, and/or the like. For example, the machine learned model can be used to determine the characteristic(s) including objects, object location, text, text associated with objects, situations (e.g., driving, walking, turning, and/or the like), and/or the like.

In step S325 the content is modified based on the characteristic(s) of the region of interest and the characteristic(s) of the content. For example, modifying the content can include changing a color of an object, changing a color of text, changing a position of an object, changing a position of a text, removing an object, and/or the like.

In step S330 the modified content is rendered on the overlay display. For example, rendering the modified image can include displaying each pixel of the modified content on the overlay display. Rendering the modified image can include projecting the modified content onto the overlay display. Rendering the modified image can include pixel-by-pixel rasterization, primitive-by-primitive rasterization, ray casting, ray tracing, and/or the like. Rendering the modified image can include converting the modified image to a geometric representation and rasterizing the geometric representation.

In an example implementation, the wearable device 110 can include a sensor and the modifying of the content can be based on an output of the sensor. For example, the sensor can detect a brightness of the environment and the content can be modified based on the detected brightness. In an example implementation, the wearable device 110 can include a sensor and the rendering of the modified content on the overlay display can be delayed based on an output of the sensor. For example, the sensor can detect a location in which the wearable device 110 is operating and the content can be modified based on the location.

In an example implementation, a parameter of the overlay display 130 can be modified based on the characteristic(s) of the region of interest and/or the characteristic(s) of the content. For example, a brightness and/or a color setting of the overlay display 130 can be modified based on the characteristic(s) of the region of interest and/or the characteristic(s) of the content. In an example implementation, the wearable device 110 can include a sensor and a parameter of the overlay display 130 can be modified based on an output of the sensor. For example, the sensor can detect a brightness of the environment and the parameter of the overlay display 130 can be modified based on the detected brightness.

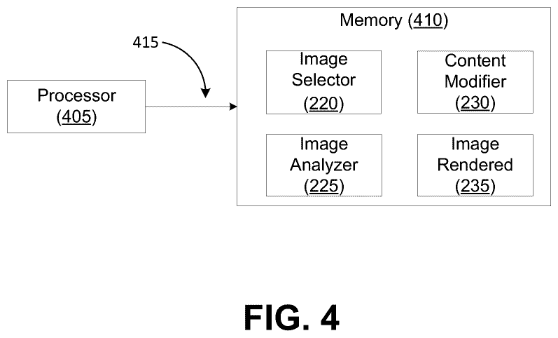

FIG. 4 illustrates a block diagram of a system according to an example implementation. In the example of FIG. 4, the system (e.g., an augmented reality system) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 405 and a memory 410 (e.g., a non-transitory computer readable memory). The processor 405 and the memory 410 can be coupled (e.g., communicatively coupled) by a bus 415.

The processor 405 may be utilized to execute instructions stored on the at least one memory 410. Therefore, the processor 405 can implement the various features and functions described herein, or additional or alternative features and functions. The processor 405 and the at least one memory 410 may be utilized for various other purposes. For example, the at least one memory 410 may represent an example of various types of memory and related hardware and software which may be used to implement any one of the modules described herein.

The at least one memory 410 may be configured to store data and/or information associated with the device. The at least one memory 410 may be a shared resource. Therefore, the at least one memory 410 may be configured to store data and/or information associated with other elements (e.g., image/video processing or wired/wireless communication) within the larger system. Together, the processor 405 and the at least one memory 410 may be utilized to implement the techniques described herein. As such, the techniques described herein can be implemented as code segments (e.g., software) stored on the memory 410 and executed by the processor 405. Accordingly, the memory 410 can include the image selector 220, the image analyzer 225, the content modifier 230, and the image renderer 235.

None, one, or more of the elements described with regard to FIG. 4 can be implemented using a split computing system. For example, a companion device including a processor and memory can be communicatively coupled with the wearable device 110. Accordingly, one or more of the image selector 220, the image analyzer 225, the content modifier 230, and/or the image renderer 235 can be implemented in the companion device and the result of the execution of the image selector 220, the image analyzer 225, the content modifier 230, and/or the image renderer 235 can be communicated to the wearable device 110.

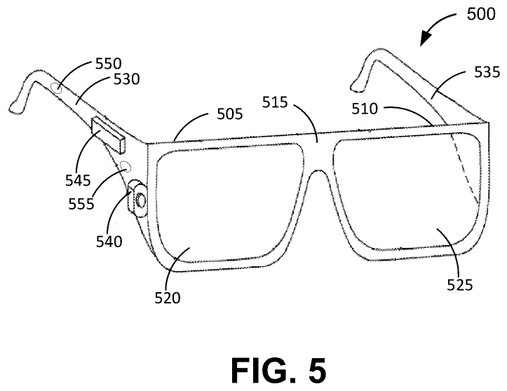

FIG. 5 illustrates a wearable device according to an example implementation. As shown in FIG. 5, a wearable device 500 includes lens frame 505, lens frame 510, center frame support 515, lens element 520, lens element 525, extending side-arm 530, extending side-arm 535, image capture device 540 (e.g., a camera), on-board computing system 545, speaker 550, and microphone 555.

Each of the frame elements 505, 510, and 515 and the extending side-arms 530, 535 can be formed of a solid structure of plastic and/or metal or can be formed of a hollow structure of similar material so as to allow wiring and component interconnects to be internally routed through the wearable device 500. Other materials can be possible as well. At least one of the lens elements 520, 525 can be formed of any material that can suitably display a projected image or graphic. Each of the lens elements 520, 525 can also be sufficiently transparent to allow a user to see through the lens element. Combining these two features of the lens elements can facilitate an augmented reality or heads-up display where the projected image or graphic is superimposed over a real-world view as perceived by the user through the lens elements.

The center frame support 515 and the extending side-arms 530, 535 are configured to secure the wearable device 500 to a user's face via a user's nose and ears, respectively. The extending side-arms 530, 535 can each be projections that extend away from the lens-frames 505, 510, respectively, and can be positioned behind a user's ears to secure the wearable device 500 to the user. The extending side-arms 530, 535 can further secure the wearable device 500 to the user by extending around a rear portion of the user's head. Additionally, or alternatively, for example, the wearable device 500 can connect to or be affixed within a head-mounted helmet structure. Other configurations for a wearable computing device are also possible.

The on-board computing system 545 is shown to be positioned on the extending side-arm 530 of the wearable device 500; however, the on-board computing system 545 can be provided on other parts of the wearable device 500 or can be remotely positioned from the wearable device 500 (e.g., the on-board computing system 545 could be wire- or wirelessly-connected to the wearable device 500). The on-board computing system 545 can include a processor and memory, for example. The on-board computing system 545 can be configured to receive and analyze data from the image capture device 540 (and possibly from other sensory devices) and generate images for output by the lens elements 520, 525.

The image capture device 540 can be, for example, a camera that is configured to capture still images and/or to capture video. In the illustrated configuration, image capture device 540 is positioned on the extending side-arm 530 of the wearable device 500; however, the image capture device 540 can be provided on other parts of the wearable device 500. The image capture device 540 can be configured to capture images at various resolutions or at different frame rates. Many image capture devices with a small form-factor, such as the cameras used in mobile phones or webcams, for example, can be incorporated into an example of the wearable device 500.

One image capture device 540 is illustrated. However, more image capture devices can be used, and each can be configured to capture the same view, or to capture different views. For example, the image capture device 540 can be forward facing to capture at least a portion of the real-world view perceived by the user. This forward-facing image captured by the image capture device 540 can then be used to generate an augmented reality where computer generated images appear to interact with or overlay the real-world view perceived by the user.

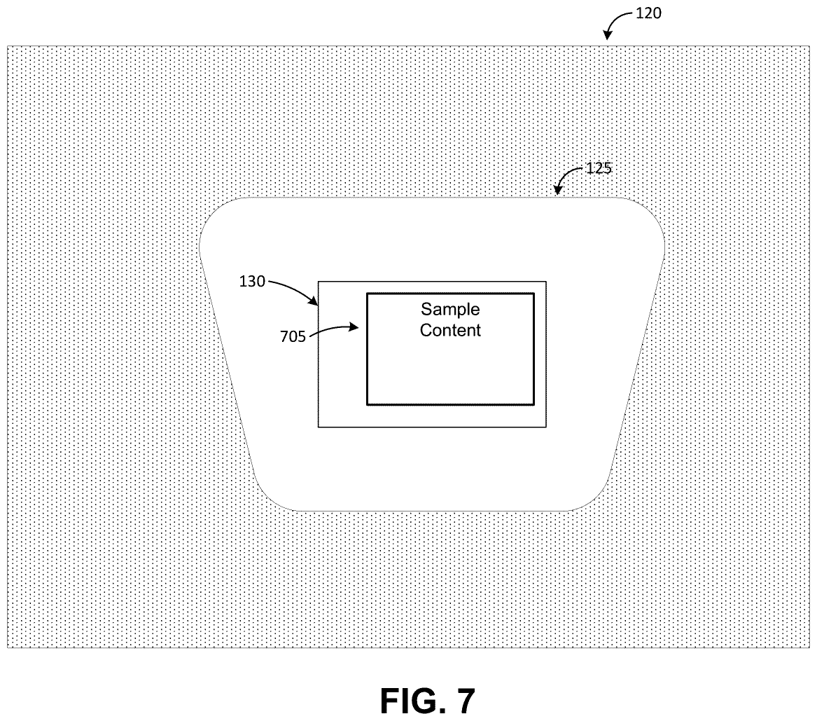

FIG. 7 illustrates a diagram of a situational display of the rendering of a modified content according to an example implementation. As shown in FIG. 7, the real-world view 120 can be viewed through the lens 125 and the overlay display 130. In some preconfigured situations or as triggered by the user 105, modifying the content can include preventing the content from being rendered on the overlay display 130. For example, the content can be prevented from being rendered while driving, while in a preconfigured location, while in a meeting, while participating in a recreational activity and/or the like. In addition, modifying the content can include preventing identified portions of the content from being rendered on the overlay display 130. For example, work related content can be prevented from being rendered while at home.

In an example implementation, the content that has been prevented from being rendered can be rendered on the overlay display 130. For example, if the selected image (e.g., the currently viewed real-world view 120) includes a preconfigured overlay object 705 (e.g., a picture frame without a picture), the content that has been prevented from being rendered can be rendered on the overlay display 130.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Network slicing and/or split computing can support customizing the capacity and capabilities of a network for different services such as wearable device computing: video/audio streaming (buffered or real-time), geolocation and route planning, sensor monitoring, computer vision, vehicular communication, etc. Edge data center processing and local data center processing augments central data center processing to allocate 5G, 6G, and future network resources to enable wearable device, smartphones, AR/VR/XR units, and other wirelessly-connected devices.

Not only can terrestrial network equipment support wearable device, video/audio streaming (buffered or real-time), geolocation and route planning, sensor monitoring, computer vision, vehicular communication, etc., non-terrestrial network equipment can enable 5G, 6G, and future wireless communications in additional environments such as marine, rural, and other locations that experience inadequate base station coverage.

As support for wearable device, computer vision, objects counting, motion detection, traffic monitoring, health monitoring, device or target localization, pedestrian avoidance, AR/VR/XR experiences, enhanced autonomous/terrestrial objects navigation, and ultra high-definition environment imaging, etc., 5G, 6G, and future wireless networks enable fine range sensing and sub-meter precision localization. Leveraging massive bandwidths and wireless resource (time, frequency, space) sharing, these wireless networks enable simultaneous communications and sensing capabilities to support radar applications in wearable devices, smart displays, smartphones, AR/VR/XR units, smart speakers, cars and other vehicles, and other wirelessly-connected devices.

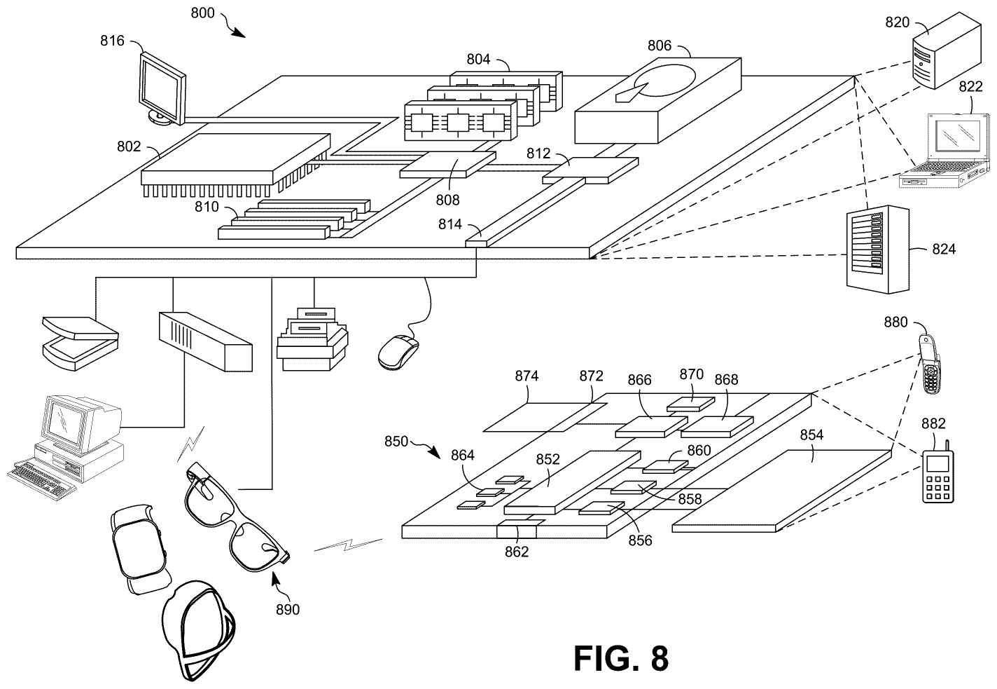

FIG. 8 illustrates an example of a computer device 800 and a mobile computer device 850, which may be used with the techniques described here (e.g., to implement the wearable device 110, a computing device including processor 405, and/or a network device communicatively coupled to the wearable device 110 and/or the computing device). The computing device 800 includes a processor 802, memory 804, a storage device 806, a high-speed interface 808 connecting to memory 804 and high-speed expansion ports 810, and a low-speed interface 812 connecting to low-speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high-speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high-speed controller 808 manages bandwidth-intensive operations for the computing device 800, while the low-speed controller 812 manages lower bandwidth-intensive operations. Such allocation of functions is example only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display), and LED (Light Emitting Diode) or an OLED (Organic Light Emitting Diode) display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In-Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 890 to generate an augmented environment for viewing inserted content within the physical space. For example, one or more sensors included on a computing device 850 or other computing device depicted in the figure, can provide input to the AR headset 890 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 850 can use the sensors to determine an absolute position and/or a detected rotation of the computing device in the AR space that can then be used as input to the AR space. For example, the computing device 850 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 850 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 850 when the computing device is incorporated into the AR space can cause a particular action to occur in the AR space.

In some implementations, a touchscreen of the computing device 850 can be rendered as a touchpad in AR space. A user can interact with the touchscreen of the computing device 850. The interactions are rendered, in AR headset 890 for example, as movements on the rendered touchpad in the AR space. The rendered movements can control virtual objects in the AR space.

In some implementations, one or more output devices included on the computing device 850 can provide output and/or feedback to a user of the AR headset 890 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 850 may appear as another object in a computer-generated, 3D environment. Interactions by the user with the computing device 850 (e.g., rotating, shaking, touching a touchscreen, swiping a finger across a touch screen) can be interpreted as interactions with the object in the AR space. In the example of the laser pointer in an AR space, the computing device 850 appears as a virtual laser pointer in the computer-generated, 3D environment. As the user manipulates the computing device 850, the user in the AR space sees movement of the laser pointer. The user receives feedback from interactions with the computing device 850 in the AR environment on the computing device 850 or on the AR headset 890. The user's interactions with the computing device may be translated to interactions with a user interface generated in the AR environment for a controllable device.

In some implementations, a computing device 850 may include a touchscreen. For example, a user can interact with the touchscreen to interact with a user interface for a controllable device. For example, the touchscreen may include user interface elements such as sliders that can control properties of the controllable device.

Computing device 800 is intended to represent various forms of digital computers and devices, including, but not limited to laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method comprising:
selecting an image from a set of images captured by a camera of a wearable device;
identifying a region of interest in the image based on a position of an overlay display of the wearable device;
determining a characteristic of the region of interest;
determining a characteristic of content to be rendered on the overlay display;
modifying the content based on the characteristic of the region of interest and the characteristic of the content; and
rendering the modified content on the overlay display.

2. The method of claim 1, wherein the region of interest includes an extended view zone.

3. The method of claim 1, wherein the determining of the characteristic of the region of interest includes:
inputting the image into a machine learned model, and
receiving the characteristic of the region of interest from the machine learned model.

4. The method of claim 1, wherein
the characteristic of the region of interest includes a first text and the characteristic of the content includes a second text that overlays a portion of the first text if rendered on the overlay display, and
the modifying of the content includes repositioning the second text such that a portion of the second text does not overlay the first text when rendering the modified content on the overlay display.

5. The method of claim 1, wherein
the characteristic of the region of interest includes a first color and the characteristic of the content includes a second color that overlays a portion of the first color if rendered on the overlay display, and
the modifying of the content includes changing the second color to contrast the first color when rendering the modified content on the overlay display.

6. The method of claim 1, wherein
the characteristic of the region of interest includes a content that is substantially the same as a portion of the content to be rendered, and
the modifying of the content includes removing the portion of the content to be rendered.

7. The method of claim 1, wherein
the wearable device includes a sensor, and
the modifying of the content is based on an output of the sensor.

8. The method of claim 1, wherein
the wearable device includes a sensor, and
the rendering of the modified content on the overlay display is delayed based on an output of the sensor.

9. The method of claim 1, further comprising:
triggering a situational display operation;
delaying the rendering of the modified content on the overlay display;
determining the characteristic of content to be rendered includes an overlay object; and
in response to determining the characteristic of content to be rendered includes the overlay object, rendering the modified content on the overlay display.

10. The method of claim 9, wherein
the delaying of the rendering of the modified content includes delaying the rendering of a portion of the modified content.

11. The method of claim 1, further comprising:
modifying a parameter of the overlay display based on the characteristic of the region of interest and the characteristic of the content.

12. The method of claim 1, wherein
the wearable device includes a sensor, and
the method further comprises modifying a parameter of the overlay display based on an output of the sensor.

13. The method of claim 1, wherein
the wearable device is communicatively coupled to a companion computing device, and
at least a portion of processing is performed on the companion computing device.

14. A non-transitory computer-readable storage medium comprising instructions stored thereon that, when executed by at least one processor, are configured to cause a computing system to:
select an image from a set of images captured by a camera of a wearable device;
identify a region of interest in the image based on a position of an overlay display of the wearable device;
determine a characteristic of the region of interest;
determine a characteristic of content to be rendered on the overlay display;
modify the content based on the characteristic of the region of interest and the characteristic of the content; and
render the modified content on the overlay display.

15. The non-transitory computer-readable storage medium of claim 14, wherein the determining of the characteristic of the region of interest includes:
inputting the image into a machine learned model, and
receiving the characteristic of the region of interest from the machine learned model.

16. The non-transitory computer-readable storage medium of claim 14, wherein
the characteristic of the region of interest includes a first text and the characteristic of the content includes a second text that overlays a portion of the first text if rendered on the overlay display, and
the modifying of the content includes repositioning the second text such that a portion of the second text does not overlay the first text when rendering the modified content on the overlay display.

17. The non-transitory computer-readable storage medium of claim 14, wherein
the characteristic of the region of interest includes a first color and the characteristic of the content includes a second color that overlays a portion of the first color if rendered on the overlay display, and
the modifying of the content includes changing the second color to contrast the first color when rendering the modified content on the overlay display.

18. The non-transitory computer-readable storage medium of claim 14, wherein
the characteristic of the region of interest includes a content that is substantially the same as a portion of the content to be rendered, and
the modifying of the content includes removing the portion of the content to be rendered.

19. The non-transitory computer-readable storage medium of claim 14, wherein
the wearable device includes a sensor, and
the modifying of the content is based on an output of the sensor.

20. The non-transitory computer-readable storage medium of claim 14, wherein the instructions further comprise:
triggering a situational display operation;
delaying the rendering of the modified content on the overlay display;
determining the characteristic of content to be rendered includes an overlay object; and
in response to determining the characteristic of content to be rendered includes the overlay object, rendering the modified content on the overlay display.
